(19) United States
(12) Patent Application Publication
(10) Pub. No.: US 2002/0101990 A1
(43) Pub. Date: Aug. 1, 2002

(54) Data receiving apparatus and data reproducing apparatus

(76) Inventors: Harumi Morino, Yokohama (JP); Masataka Okayama, Yokohama (JP); Takeo Tomokane, Yokohamai (JP); Tomohisa Kohiyama, yokohamai (JP)

Correspondence Address: Mattingly, Stanger & Malur, P.C., 104 East Hume Avenue, Alexandrira, VA, 22301, US

(21) Appl. No.: 09/793,114

(22) Filed: Feb. 27, 2001

(30) Foreign Application Priority Data
Feb. 1, 2001 (JP) 2001-025011

(51) Int. Cl. H04N 7/167

(52) U.S. Cl. 380/210; 725/31

(57) ABSTRACT

A data receiving apparatus has a tuner for receiving enciphered contents and an enciphered scramble key, a local CPU for deciphering the enciphered scramble key by using a work key in an IC card, a Ks encipher unit for generating an encipher key for re-enciphering the deciphered scramble key and a decipher key for re-deciphering the re-enciphered scramble key in accordance with an identification ID specific to the apparatus and an arbitrary random number and for re-enciphering the deciphered scramble key by using the encipher key, a key storage area for storing the decipher key, and a bus I/F unit for transferring the re-enciphered scramble key and enciphered contents to an external apparatus.

### BACKGROUND OF THE INVENTION

The present invention relates to a data receiving apparatus for receiving enciphered contents and to an information processing apparatus having such a data receiving apparatus, and more particularly to a data receiving apparatus for receiving digital broadcasting data or data transmitted via a network and to an information processing apparatus having such a data receiving apparatus. The data receiving apparatus may be a television receiver (tuner), a video recorder, a set top box and the like. The information processing apparatus may be a personal computer, a work station, and a mobile phone.

Recent data distribution via satellite broadcasting supplies users with enciphered video and audio contents. “CONDITIONAL ACCESS SPECIFICATION FOR DIGITAL SATELLITE BROADCASTING SERVICES USING BROADCASTING SATELLITES”, ARIB.STD-B25 describes a conditional reception method for BS digital broadcasting. The contents of this, i.e., the conditional reception method of receiving enciphered BS digital broadcasting data, is illustrated in FIG. 2. With reference to FIG. 2, a data flow will be described. First, contents such as video and audio contents are enciphered by a scramble key Ks 102 at a contents encipher unit 101. The scramble key Ks 102 is enciphered by a work key Kw 103 at an encipher unit 106. The work key Kw 103 and contract information 104 are enciphered by a master key Km 105 at an encipher unit 107. These enciphered contents, scramble key Ks, work key Kw, and contract information are multiplexed at a multiplexer 108 and distributed to a receiver 120. At the receiver 120, a demultiplexer 118 demultiplexes the received multiplexed data into the enciphered contents, scramble key Ks, work key Kw, and contract information. The enciphered work key Kw and contract information are deciphered by a master key 115 at a decipher unit (descramber) 117 and the deciphered work key Kw and contract information 114 are stored. The enciphered scramble key is deciphered by a work key Kw at the decipher unit 116 to obtain a deciphered scramble key Ks. The enciphered contents are judged by a listening/viewing judgement unit 119 by using contract information 114 whether the contents can be listened/viewed. If it is judged that the contents can be listened/viewed, the contents are deciphered by the scramble key Ks at a contents decipher unit 111. Although the enciphered scramble key Ks is received by all receivers, the work key Kw and contract information are specific to each receiver and they are enciphered by the master key unique to each receiver and other receivers cannot decipher them. Therefore, contents not contracted cannot be received because the work key Kw necessary for deciphering the scramble key Ks cannot be obtained. Although the master key Km is not changed, the work key Kw is changed at the contract time and after about six months or one year and the scramble key Ks is updated at an interval of about several seconds. Therefore, even if the work key Kw for the contents not contracted can be known, listening/viewing of only about one year is possible, and even if the scramble key Ks can be known, listening/viewing of only about several seconds is possible. The decipher units 116 and 117, master key 115, contract information 114 and listening/viewing judgment unit 119 shown in FIG. 2 are realized by an IC card. A receiving board for BS digital broadcasting connectable to a personal computer (PC) such as shown in FIG. 3 is also known.

### SUMMARY OF THE INVENTION

The following problems occur when contents are recorded. These problems will be explained by taking as an example of the receiving board shown in FIG. 3. Similar problems are also associated with a TV receiver, a set top box, and a video recorder, if the information processing apparatus including PC has the receiving board.

It is assumed herein that a personal computer (PC) is used as a recording apparatus, PC being connected to a BS digital broadcasting receiving board as shown in FIG. 3. Digital data received at a tuner 11 is demultiplexed by a demultiplexer 13 into an enciphered scramble key Ks, work key Kw and contract information and sent to an IC card 16 via a local bus 24 under the control of a local CPU 15. As described earlier, the IC card 16 stores the work key Kw and contract information and deciphers an enciphered scramble key Ks. This deciphered scramble key Ks is supplied to a contents decipher unit 12 to decipher enciphered contents. The deciphered contents are decoded by a contents decoder 14 and output from an output device 30 such as a monitor and a speaker. In this case, it is possible also to directly output the deciphered contents not to the output device 30 but to a display control unit 6 of PC. In recording contents in a storage unit 5 such as HDD of PC, the contents demultiplexed by the demultiplexer 13 are sent to a bus I/F unit 23 via the local bus 24 and stored in a main memory 3 via a PC internal PCI bus 4 and a bus bridge 2. When a certain amount of contents is stored in the main memory 3, CPU 1 operates to store the contents in the storage unit 5. The contents stored in the storage unit 5 are not enciphered and can be easily copied by using file utility applications. It is therefore difficult to protect a copyright of contents.

In order to protect a copyright of contents, the enciphered contents and scramble key Ks may be stored in the storage unit 5. However, in this case, as described earlier, the work key Kw is changed in about six months or one year. Therefore, if a long time elapses, the contents cannot be listened/viewed.

It is an object of the present invention to provide a data receiving apparatus and an information processing apparatus capable of managing contents by using a proper storage medium or storage unit at a listening/viewing side, while a right of authors or the like of contents is protected.

In order to achieve this object, in this invention, for enciphered data to be deciphered by a data decipher key whose contents are changed as time lapses, data enciphered by a first encipher key is received, at least one of the received data and the data decipher key enciphered by a second encipher key is deciphered, and the data deciphered or the data decipher key is enciphered by a re-encipher key at an encipher unit, and the re-enciphered data or the data decipher key is stored in a storage medium connected to the encipher unit.

The scope of this invention also includes reproduction of data stored in a recording medium.

### BRIEF DESCRIPTION OF THE DRAWINGS

FIG. 1 is a block diagram showing the structure of an information processing apparatus according to a first embodiment of the invention.

FIG. 2 is a block diagram showing the structure of a conventional apparatus using a limited reception method.

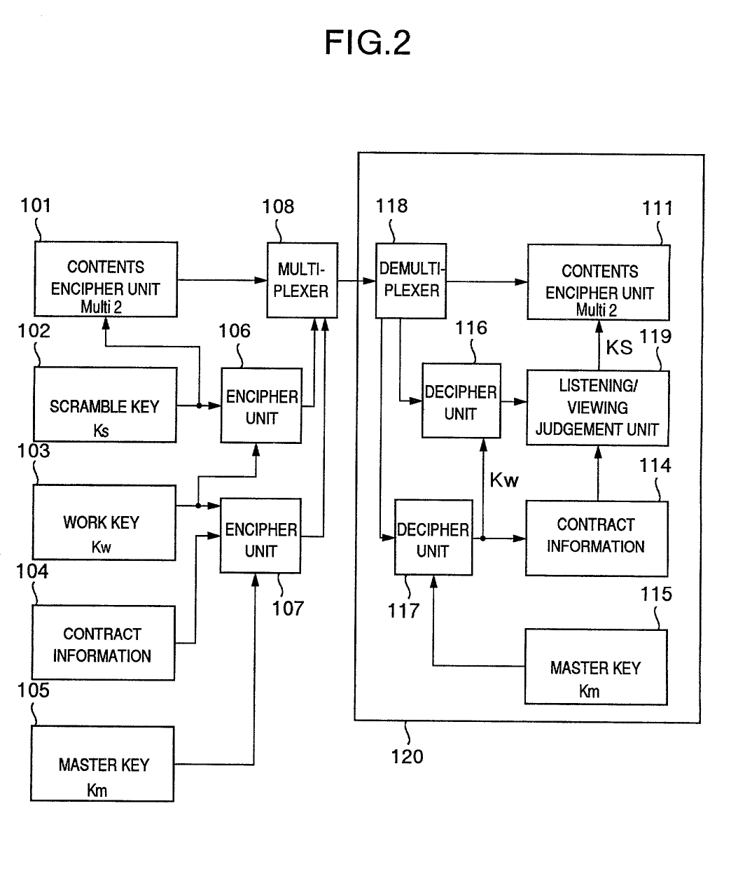

FIG. 3 is a block diagram showing the structure of an information processing apparatus for receiving and recording digital broadcasting data.

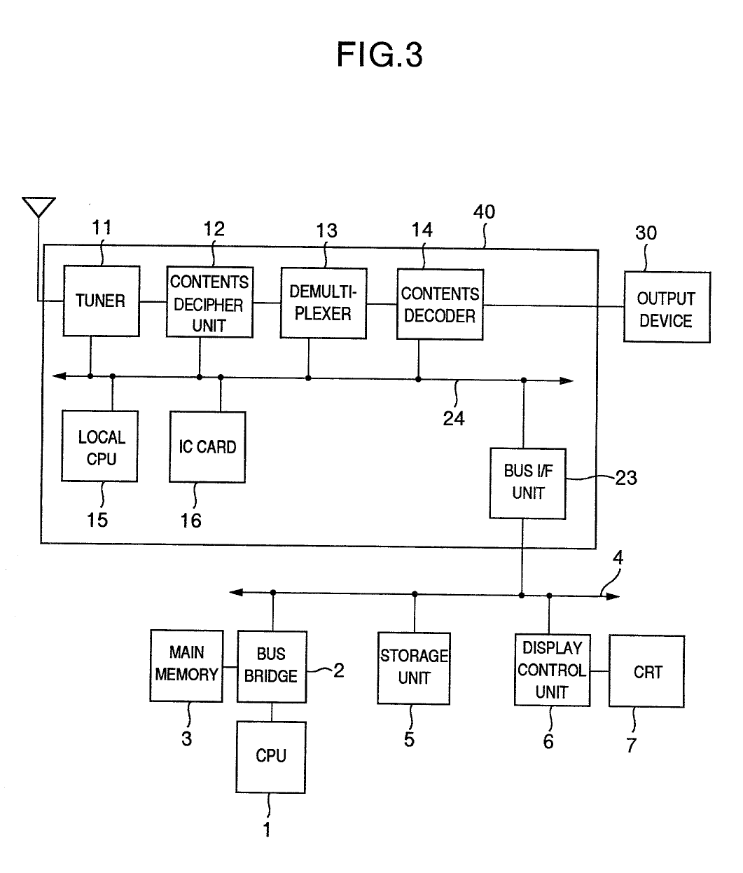

FIG. 4 is a block diagram showing the structure of an encipher unit for re-enciphering a scramble key according to the first embodiment of the invention.

FIG. 5 is a block diagram showing the structure of an information processing apparatus according to a second embodiment of the invention.

FIG. 6 is a block diagram showing the structure of an information processing apparatus according to a third embodiment of the invention.

FIG. 7 is a block diagram showing the structure of an information processing apparatus according to a fourth embodiment of the invention.

FIG. 8 is a block diagram showing the structure of an information processing apparatus according to a fifth embodiment of the invention.

FIG. 9 is a block diagram showing the structure of an information processing apparatus according to a sixth embodiment of the invention.

FIG. 10 is a sequence diagram illustrating an example of data transfer for storing a key through cipher communications.

FIG. 11 is a sequence diagram illustrating an example of data transfer for acquiring a key through cipher communications.

FIG. 12 is a block diagram showing the structure of an information processing apparatus according to a seventh embodiment of the invention.

FIG. 13 is a block diagram showing the structure of an information processing apparatus according to an eighth embodiment of the invention.

### DETAILED DESCRIPTION OF THE EMBODIMENTS

Embodiments of the invention will be described with reference to the accompanying drawings.

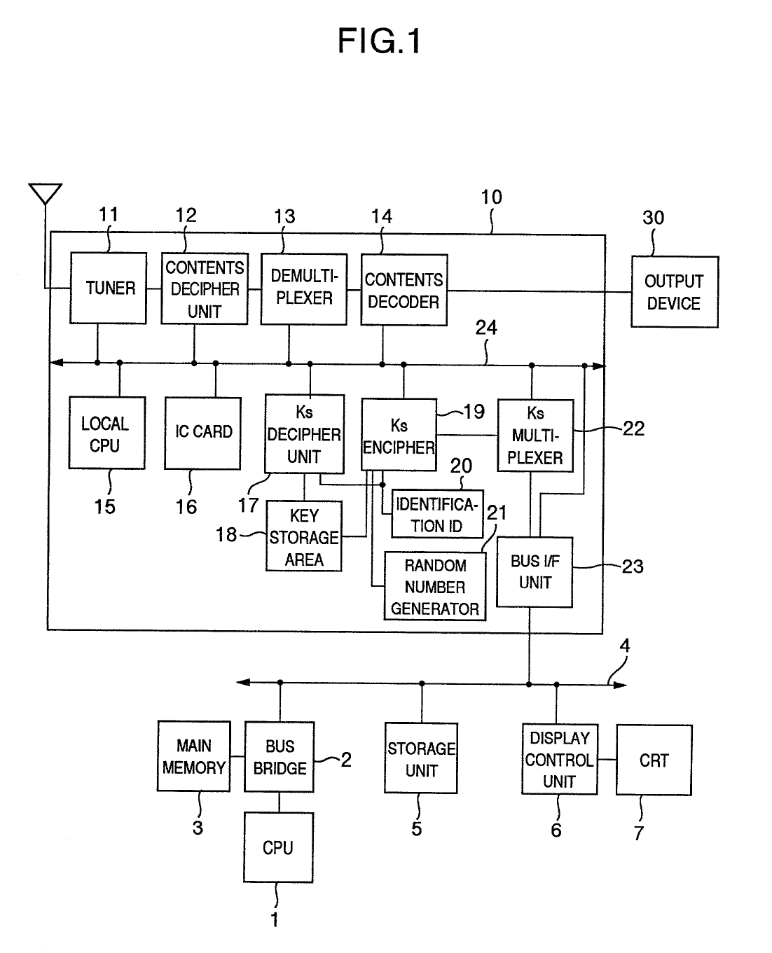

FIG. 1 is a block diagram showing the structure of an information processing apparatus of this invention. In FIG. 1, reference numeral 19 represents a Ks encipher unit for re-enciphering a scramble key. Reference numeral 20 represents an identification ID storage area for storing an identification ID (Identifier) which is identification information unique to each data receiving apparatus 10 or each information processing apparatus, reference numeral 21 represents a random number generator for generating a random number, and reference numeral 18 represents a key storage area for storing a contents ID and a key for deciphering a scramble key enciphered by the Ks encipher unit 19. Reference numeral 22 represents a Ks multiplexer for multiplexing the re-enciphered scramble key Ks upon enciphered contents. Reference numeral 17 represents a decipher unit for deciphering the re-enciphered scramble key Ks.

The information processing apparatus includes: a data receiving apparatus 10 for receiving data and deciphering and re-enciphering it; an output device 30 for listening/viewing contents; an information processing apparatus main body for executing information processing; and a CRT (Cathode-Ray Tube) 7 for displaying images.

The information processing apparatus main body includes: a CPU (Central Processing Unit) 1 for performing arithmetic and logical operations; a main memory 3 (e.g., RAM (Random Access Memory) for storing data and programs; a bus bridge 2; a storage unit (e.g., HDD) 5 for storing data and programs; and a display control unit 6 for controlling display operations. The data receiving apparatus 10, CPU 1, main memory 3, bus bridge 2, storage unit 5 and display control unit 6 are interconnected by a PCI (Peripheral Component Interconnect) bus 4. The storage unit 5 may be a writable or rewritable storage medium such as a floppy disc, a CD-R, a CD-RW, a DVD-R, a DVD-RW, a DVD-ROM, and an MO. The storage unit may be any storage unit which can store data and information.

The information processing apparatus may be PC, a work station or a mobile phone.

The data receiving apparatus 10 includes: a tuner 11 for receiving broadcasting data; a contents decipher unit 12 for deciphering enciphered contents; a demultiplexer 13 for demultiplexing received broadcasting data into enciphered contents and an enciphered scramble key Ks; a contents decoder 14 for decoding contents; a local CPU 15 for performing arithmetic and logical operations; an IC card 16 for storing a work key Kw and contract information and deciphering a scramble key Ks enciphered by the work key Kw; a decipher unit 17 for deciphering a re-enciphered scramble key Ks; a key storage area 18 for storing a contents ID and a key for deciphering the re-enciphered scramble key Ks; a Ks encipher unit 19 for re-enciphering the scramble key Ks; an identification ID storage area 20 for storing an identification ID; a random number generator 21 for generating a random number; a Ks multiplexer 22 for multiplexing the re-enciphered scramble key Ks upon the enciphered contents, and a bus I/F unit 23 for interface with the PCI bus 4. These components are interconnected by the local bus 24. The tuner 11 may be a receiver for receiving data transmitted via a network, such as a modem and a TA. The IC card 16 can be disconnected (removed) from the data receiving apparatus 10. Although the work key Kw is preferably stored in the IC card 16, it may be stored in a server accessible via a network. If the work key Kw is stored in a server, it is acquired via the network.

Next, the processes to be executed by the information processing apparatus will be described. It is assumed herein that the work key Kw and contract information are stored beforehand in the IC card 16. First, an operation of recording contents will be described. Enciphered broadcasting data (program) is received by the tuner 11 and passes through the contents decipher unit 12, and the demultiplexer 13 demultiplexes received broadcasting data into enciphered contents and an enciphered scramble key Ks. The demultiplexed and enciphered scramble key Ks is deciphered by the work key Kw in the IC card 16 under the control of the local CPU 15. The scramble key Ks deciphered by the local CPU 15 is transferred to the Ks encipher unit 19. The Ks encipher unit 19 re-enciphers the scramble key Ks by using a random number generated by the random number generator 21 and the identification ID which is stored in the identification ID storage area and is identification information unique to the data receiving apparatus 10. The contents ID designated by CPU 1 and indicating re-encipher is transferred to the Ks encipher unit 19 via the bus bridge 2 and bus I/F unit 23. After the re-encipher, the Ks encipher unit 19 transfers the contents ID and the re-enciphered scramble key Ks to the Ks multiplexer 22. The Ks encipher unit 19 stores a pair of the key for deciphering the re-enciphered scramble key Ks and the contents ID in the key storage area 18. The Ks multiplexer 22 multiplexes the contents ID upon the re-enciphered scramble key Ks and transfers the multiplexed data to the bus I/F unit 23. The bus I/F unit transfers this multiplexed data to the main memory 3 via the PCI bus 4 and bus bridge 2. When a certain amount of contents is stored in the main memory 3, CPU 1 operates to store the contents in the storage unit 5 such as HDD.

An operation of reproducing the recorded contents will be described. CPU 1 reads the multiplexed data stored in the storage unit 5 and inputs it in the contents decipher unit 12 via the PCI bus 4 and bus I/F unit 23. The multiplexed data is supplied to the demultiplexer 13 whereat it is demultiplexed into the enciphered scramble key Ks which is supplied to the local CPU 15. After the local CPU 15 confirms the contents ID indicating re-encipher, it supplies the contents ID and the enciphered scramble key Ks to the Ks decipher unit 17. By referring to the contents ID, the Ks decipher unit 17 reads the key for deciphering the corresponding re-enciphered scramble key Ks from the key storage area 18 and deciphers the re-enciphered scramble key Ks by using the read key and identification ID. Upon reception of the deciphered scramble key Ks, the local CPU 15 sets it to the contents decipher unit 12 to decipher the enciphered contents. The deciphered contents are decoded by the contents decoder 14 and supplied to the output device 30 to enable listening/viewing.

As described above, the enciphered contents are recorded after multiplexing the enciphered contents upon the scramble key Ks re-enciphered by using the identification ID unique to the data receiving apparatus. Therefore, even if the file is copied and another information processing apparatus or data reproducing apparatus tries to reproduce it, the scramble key Ks cannot be enciphered because of a different identification ID and a copy right of contents can be protected. Since the key stored in the key storage area 18 is not updated, there is no time limited reproduction.

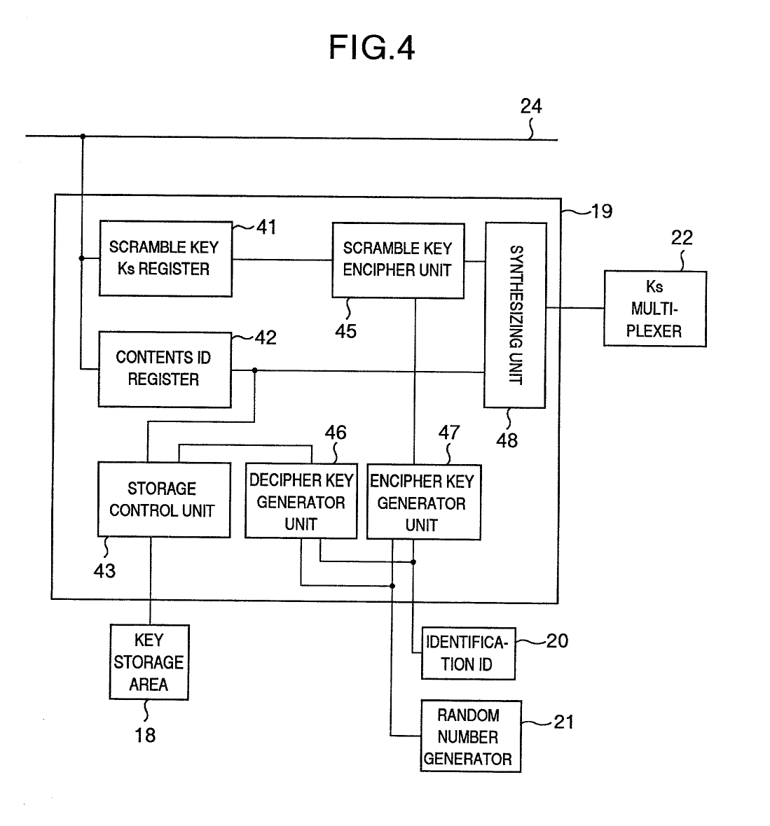

The Ks encipher unit 19 characteristic to this invention will be described in detail with reference to FIG. 4. In FIG. 4, reference numeral 41 represents a scramble key Ks register for storing the scramble key Ks, reference numeral 42 represents a contents ID register for storing the contents ID, reference numeral 45 represents a scramble key encipher unit for re-enciphering the scramble key Ks, reference numeral 46 represents a deciphered key generator unit for generating a key for deciphering the enciphered scramble key, reference numeral 47 represents an encipher key generator unit for generating a key for enciphering the scramble key Ks, and reference numeral 48 represents a synthesizing unit for synthesizing the contents ID and re-enciphered scramble key Ks. The Ks encipher unit 19 includes the scramble key Ks register 41, the contents ID register 42, a storage control unit 43, the scramble key encipher unit 45, the decipher key generator unit 46, the encipher key generator unit 47 and the synthesizing unit 48.

Next, the processes to be executed by the Ks encipher unit 19 constructed as above will be described. The local CPU 15 sets the scramble key Ks deciphered by the IC card to the scramble key register 41, and CPU 1 sets the contents ID to the contents ID register 42. The encipher key generator units 47 generates an encipher key through predetermined calculations of the identification ID and a random number generated by the random number generator 21. This encipher key is supplied to the scramble key encipher unit 45 which enciphers the scramble key Ks stored in the scramble key register 41 and supplies the enciphered scramble key to the synthesizing unit 48. The synthesizing unit 48 synthesizes the enciphered scramble key Ks and the contents ID stored in the contents ID register 42, and sends the synthesized data to the Ks multiplexer 22. Since the contents ID are not enciphered, CPU 1 can confirm it. Therefore, the contents ID of the multiplexed and recorded data can be confirmed before reproducing the contents. Further, the decipher key generator unit 46 generates the decipher key through predetermined calculations of the identification ID and a random number generated by the random number generator 21. The storage control unit 43 stores a pair of this decipher key and the contents ID in the key storage area 18.

The invention is not limited only to receiving broadcasting data transmitted over broadcasting waves, but is applicable to receiving data transmitted via a network (the Internet, local area network or the like) and to receiving data transmitted from another information processing apparatus.

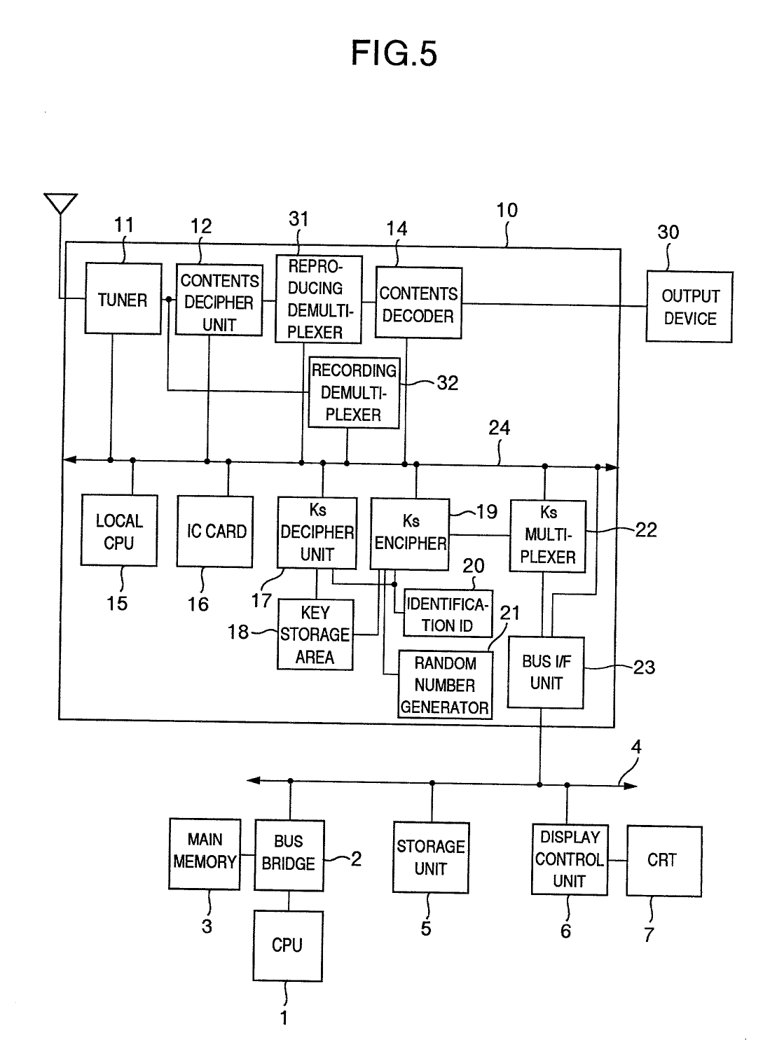

Next, the second embodiment will be described with reference to FIG. 5. In FIG. 5, reference numeral 31 represents a reproducing demultiplexer used when contents are reproduced, and reference numeral 32 represents a recording demultiplexer used when contents are recorded. In the first embodiment, since the enciphered contents are transferred while the contents are recorded, the enciphered contents are not deciphered. Namely, data passed through the contents decipher unit 12 without any operation thereat and transferred to the demultiplexer 13 is the enciphered contents themselves so that the contents cannot be decoded by the contents decoder 14. Namely, during recording contents, the contents cannot be listened/viewed. In the second embodiment shown in FIG. 5, the reproducing and recording demultiplexers 31 and 32 are provided to allow the contents during recording can be listened/viewed.

The processes to be executed by the second embodiment are as follows. The reproducing demultiplexer 31 demultiplexes the enciphered scramble key Ks which is deciphered in the IC card under the control of the local CPU 15 and set to the contents decipher unit 12 to decipher the enciphered contents. Therefore, the contents supplied from the reproducing demultiplexer 31 are deciphered contents which can be decoded at the contents decoder 14 to allow listening/viewing. The recording demultiplexer 32 does not require deciphered contents so that it receives an output from the tuner, demultiplexes the enciphered contents, transfers them to the Ks multiplexer 22 to allow recording to the storage unit 5.

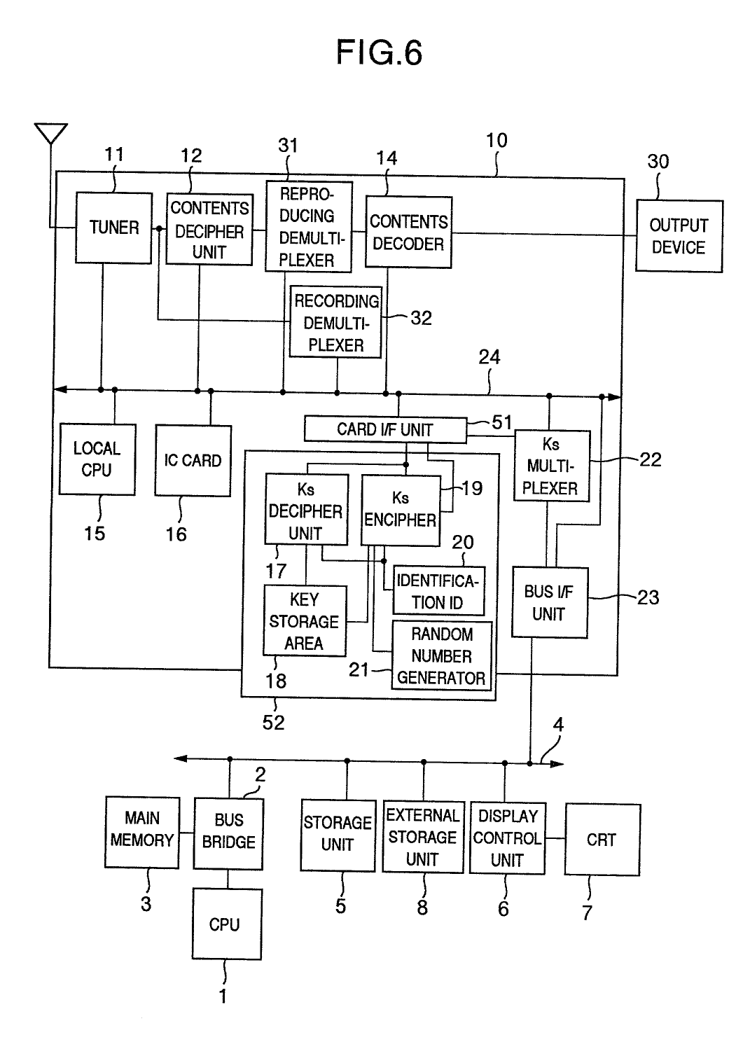

Next, the third embodiment will be described with reference to FIG. 6. In FIG. 6, reference numeral 52 represents a scramble key encipher/decipher card which is removable and has the functions of the Ks decipher unit 17, Ks encipher unit 19, identification ID storage area 20, random number generator 21 and key storage area 18 of the first and second embodiments. The scramble key encipher/decipher card 52 is connected via a card I/F unit 51 to the local bus 24. Since the re-enciphered scramble key Ks and contents ID are also supplied to the Ks multiplexer 22 via the card I/F unit 51, access to the Ks decipher unit 17 and Ks encipher unit 18 can be performed in the manner similar to the first and second embodiments. The scramble key encipher/decipher card 52 can be disconnected (removed) from the data receiving apparatus 10. The identification ID is preferably an ID unique to each scramble key encipher/decipher card 51. In this case, contents of multiplexed data recorded, for example, in the storage unit 5, and copied to an external storage unit 8 such as DVD-RAM, CD-R and CD-RW can be listened/viewed even by another information processing apparatus connected to the data receiving apparatus 10 of this invention with the external storage unit 8 and scramble key encipher/decipher card 51. If some functions of the scramble key encipher/decipher card 51 are included in the IC card 16, the number of cards 51 can be reduced, which is easy to be conceivable.

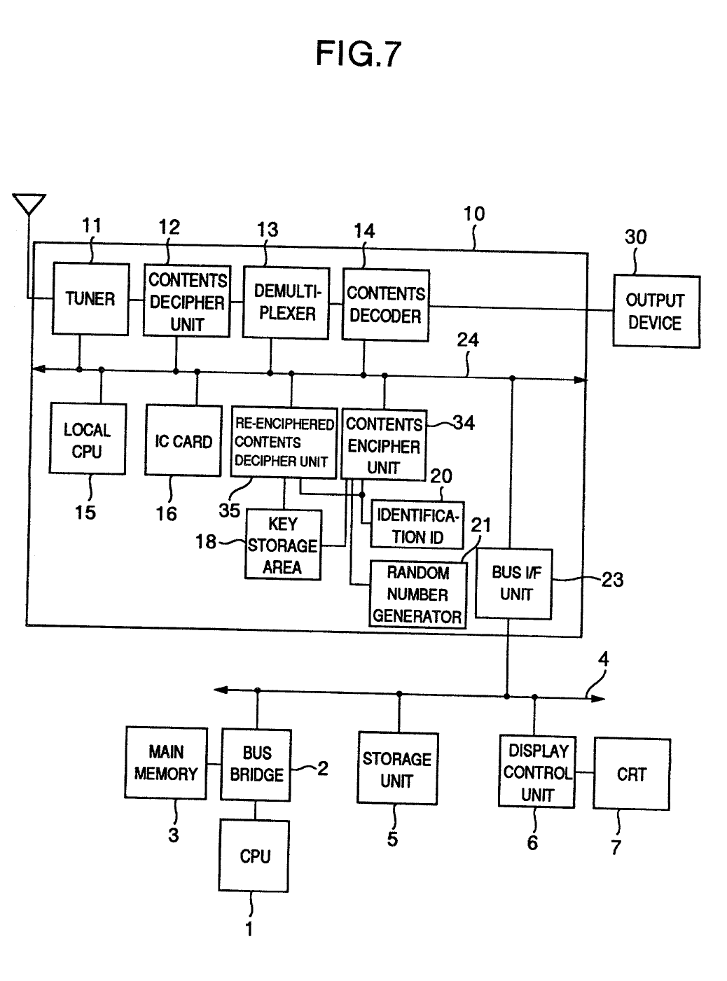

Next, with reference to FIG.7, the fourth embodiment will be described. In FIG. 7, reference numeral 34 represents a contents encipher unit for re-enciphering contents, and reference numeral 35 represents a re-enciphered contents decipher unit for deciphering re-enciphered contents.

First, an operation of recording contents will be described. Enciphered broadcasting data (program) is received by the tuner 11 and passes through the contents decipher unit 12, and the demultiplexer 13 demultiplexes received broadcasting data into enciphered contents and an enciphered scramble key Ks. The demultiplexed and enciphered scramble key Ks is deciphered in the IC card 16 under the control of the local CPU 15. The scrambled key Ks deciphered by the local CPU 15 is set to the contents decipher unit 12. The contents deciphered by the contents decipher unit 12 are sent via the demultiplexer 13 to the contents decoder 14 and contents encipher unit 34. The contents decoded by the contents decoder 14 are output to the output device 30 to listen/view the contents. The contents encipher unit 34 enciphers the contents by using a random number generated by the random number generator 21 and the identification ID which is identification information unique to each data receiving apparatus. The contents ID designated by CPU 1 and indicating re-encipher are transferred to the contents encipher unit 34 via the bus bridge 2 and bus I/F unit 23. After the re-encipher, the contents encipher unit 34 transfers the contents ID and re-enciphered contents to the bus I/F unit 23. The contents encipher unit 34 stores the contents ID and a key for deciphering the re-enciphered contents, in the key storage area 18. The bus I/F unit transfers the multiplexed data to the main memory 3 via the PCI bus 4 and bus bridge 2. When a certain amount of contents is stored in the main memory 3, CPU 1 operates to store the contents in the storage unit 5 such as HDD. An operation of reproducing recorded contents will be described. CPU 1 reads the re-enciphered data stored in the storage unit 5 and inputs it to the re-enciphered contents decipher unit 35 via the PCI bus 4 and bus I/F unit 23. In this case, a key corresponding to the contents ID is read from the key storage area 18 to decipher the re-enciphered contents. The deciphered contents are input to the demultiplexer 13 to delete unnecessary data such as the contents ID and transfer the remaining data to the contents decoder 14. The contents decoded by the contents decoder 14 are output to the output device 30 to listen/view the contents. If a cipher algorithm used by the contents encipher unit 34 is made the same as that used when a broadcaster enciphers contents, the contents decipher unit 12 and re-enciphered contents decipher unit 35 may be replaced by a common decipher unit. As described above, also in this embodiment, the contents stored in the storage unit 5 are being enciphered so that similar advantages to those of the first embodiment can be obtained.

As described so far, according to the first to fourth embodiments, in a broadcasting data receiving apparatus, since the enciphered key for deciphering enciphered contents is deciphered and re-enciphered, it is possible to store enciphered contents themselves in the storage unit. Therefore, even for an information processing apparatus such as PC on which file utility applications run, a data receiving apparatus can be provided which can protect a copyright of contents and can listen/view contents even if the work key Kw is changed. By making the function of deciphering and re-enciphering the enciphered key for deciphering enciphered contents to have a removable circuit structure, it is possible to allow another data processing apparatus to listen/view contents.

The first to fourth embodiments described above may be used in combination.

The processes of the apparatus of the first to fourth embodiments may be executed either by hardware or by programs (software). Such programs may be stored in a storage medium (e.g., floppy disc, CD-ROM, DVD-ROM, MO or the like), or in a server which is accessible via a network. If programs are stored in a server, they can be downloaded via the network.

According to the first to fourth embodiments, enciphered contents can be transferred in the state that the contents cannot be deciphered. It is therefore advantageous in that a listener/viewer side can manage contents by using a proper storage medium or storage unit while a copyright or the like of contents is protected.

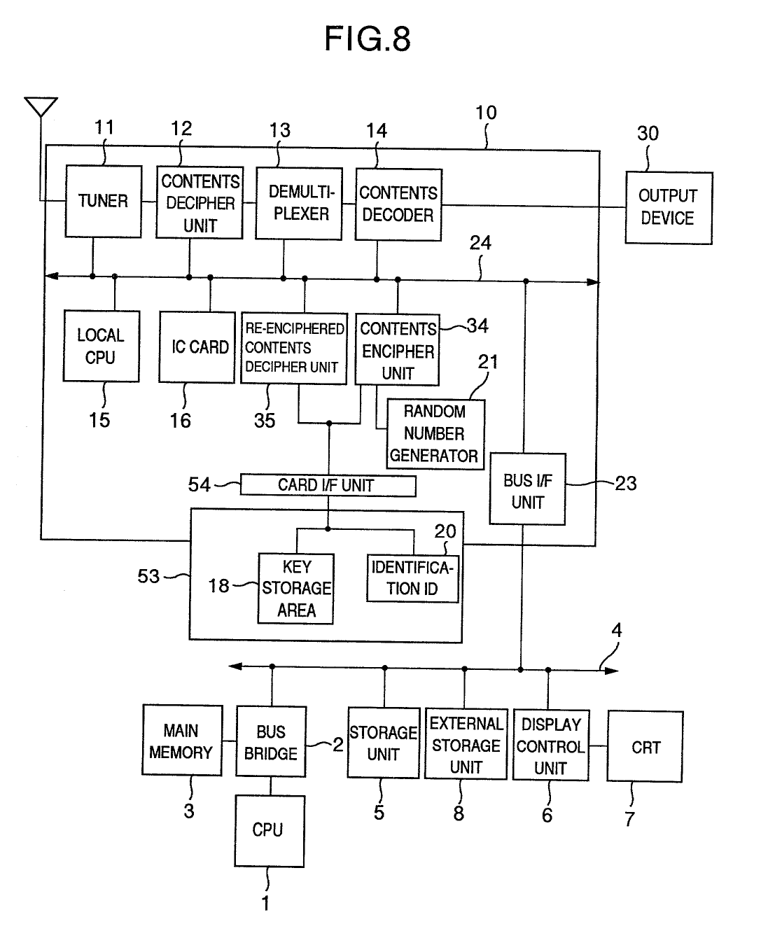

Next, with reference to FIG. 8, the fifth embodiment will be described. In FIG. 8, reference numeral 53 represents a key storage card which is removable and has the functions of the key storage area 18 and identification ID 20 of the fourth embodiment. The key storage card 53 is connected via a card I/F unit 54 to the contents encipher unit 34 and re-enciphered contents decipher unit 35, so that access to the contents encipher unit 34 and re-enciphered contents decipher unit 35 can be performed in the manner similar to the fourth embodiment. Further, as described with the third embodiment, if the identification ID is an ID unique to each key storage card 53, contents of multiplexed data recorded, for example, in the storage unit 5, and copied to an external storage unit 8 such as DVD-RAM, can be listened/viewed even by another information processing apparatus connected to the data receiving apparatus 10 of this invention with the external storage unit 8 and key storage card 53.

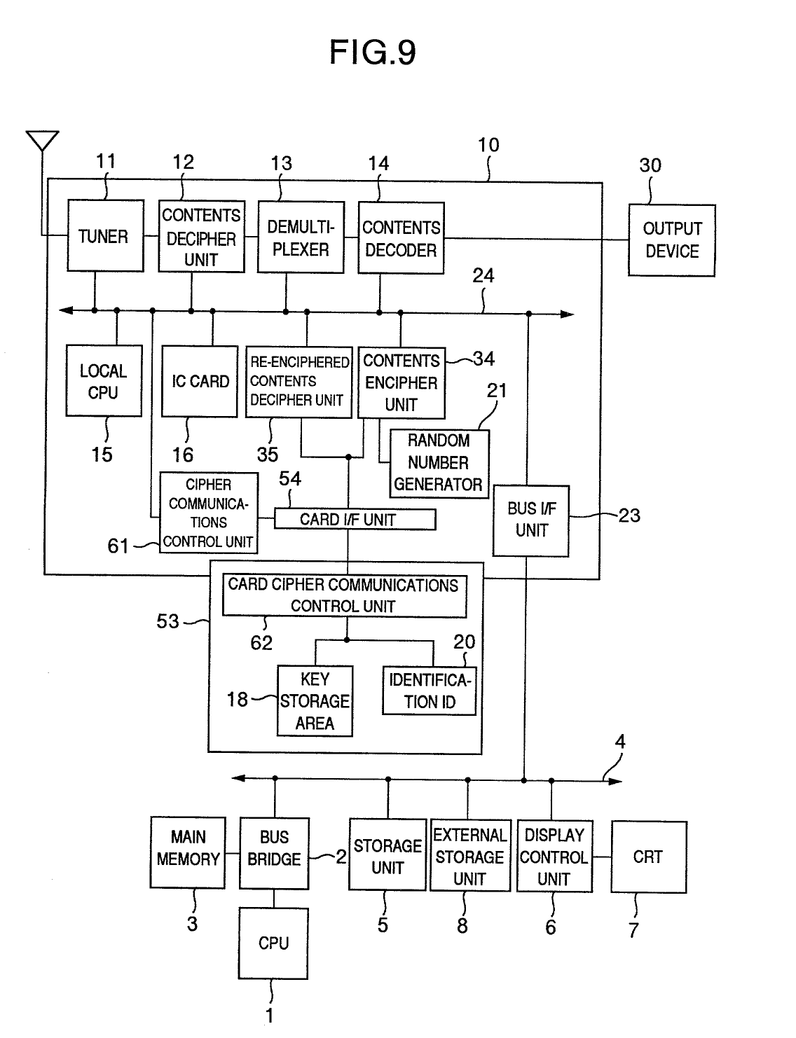

Next, the sixth embodiment will be described with reference to FIGS. 9 to 11. The structure of the apparatus will first be described with reference to FIG. 9. In FIG. 9, reference numeral 61 represents a cipher communications control unit on the side of a digital broadcasting data transfer processing apparatus 10, and reference numeral 62 represents a card cipher communications control unit on the side of the key storage card 53, both the control units 61 and 62 being used for cipher communications control during data transfer via a card I/F unit 54. In the third and fifth embodiments described above, key information is transferred via the card I/F unit. Therefore, if a protocol of the card I/F unit is already known or standardized so that the it is available by general users, then users can know the key by probing signals of the card. In order to prevent a user from easily obtaining key information or the like, data transferred between the card I/F unit 54 and key storage card 53 is enciphered by using the cipher communications control unit 61 and card cipher communication control unit 62.

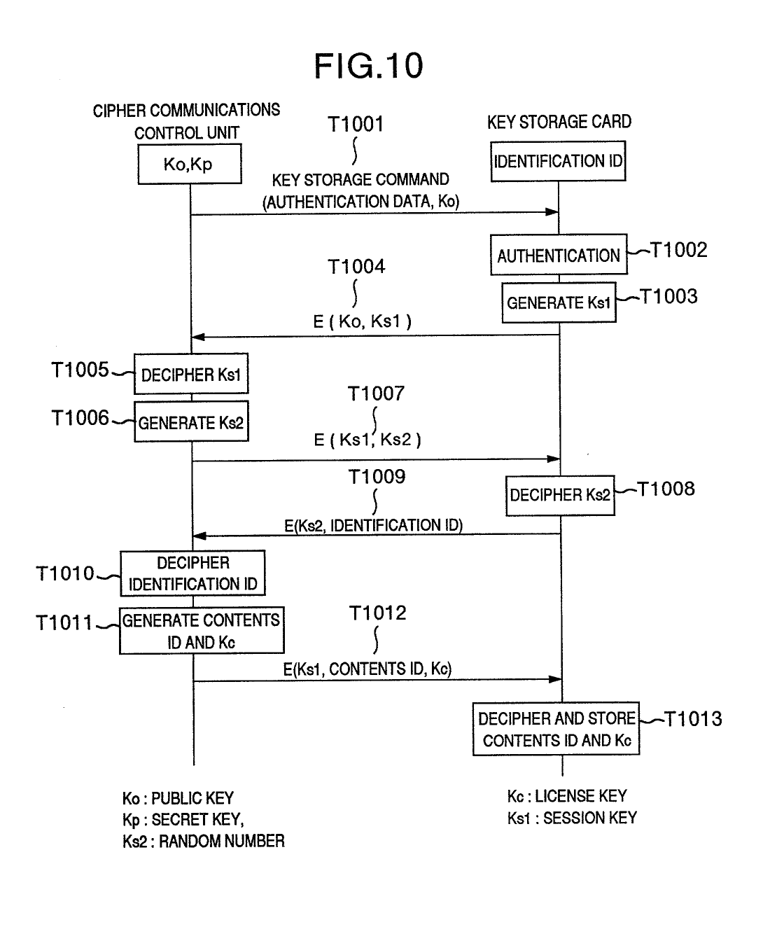

A procedure of storing a key will be described with reference to FIG. 10. Ko is a public key of the public key system which key is used when data is enciphered, and Kp is a secret key of the public key system which key is used when enciphered data is deciphered. Kc is a contents key described with the fourth embodiment, which key is used when re-enciphered contents are deciphered. The cipher communications control unit 61 generates a key storage command including authentication data of the unit 61 and the public key Ko held beforehand by the unit 61 and paired to the secret key Kp, and transmits this command to the key storage card 53 (T1001). Upon reception of this command, the card cipher communications control unit 62 of the key storage card 53 authenticates the digital broadcasting data transfer processing apparatus 10 (T1002). The card cipher communications control unit 62 generates a session key Ks1 by using a random number or the like (T1003), enciphers the session key Ks1 by using Ko contained in the key storage command, and transmits it to the cipher communications control unit 61 of the digital broadcasting data transfer processing apparatus 10 at the transmission originating side (T1004). Upon reception of this, the cipher communications control unit 61 deciphers the ciphered session key Ks1 by using the secret key Kp held in advance to obtain a deciphered session key Ks1 (T1005), and a random number Ks2 is generated (T1006). This random number Ks2 is enciphered by the session key Ks1 and transmitted to the key storage card 53 (T1007). The card cipher communications control unit 62 of the key storage card 53 deciphers the ciphered random number Ks21 by the session key Ks1 to obtain a random number Ks2 (T1008). The identification ID 20 necessary for enciphering contents is enciphered by the random number Ks2 and transmitted to the cipher communications control unit 61 (T1009). The cipher communications control unit 61 deciphers the identification ID enciphered by Ks2 to obtain the identification ID (T1001), acquires a license key Kc necessary for deciphering the contents ID and contents from the contents encipher unit 34 (T1011), and enciphers the identification ID and license key Kc by the session key Ks1 to transmit them to the key storage card 53. The card cipher communications control unit 62 of the key storage card 53 deciphers them by Ks1 to obtain the contents ID and license key Kc which are stored in the key storage area 18. In this manner, the identification ID necessary for deciphering contents, contents ID and license key Kc are transferred as ciphered data, and in addition, the session key Ks1 and random number Ks1 used for such encipher are generated by using a random number or the like. Therefore, the ciphered data becomes different at each data transfer so that it becomes difficult to know the key only by probing signals.

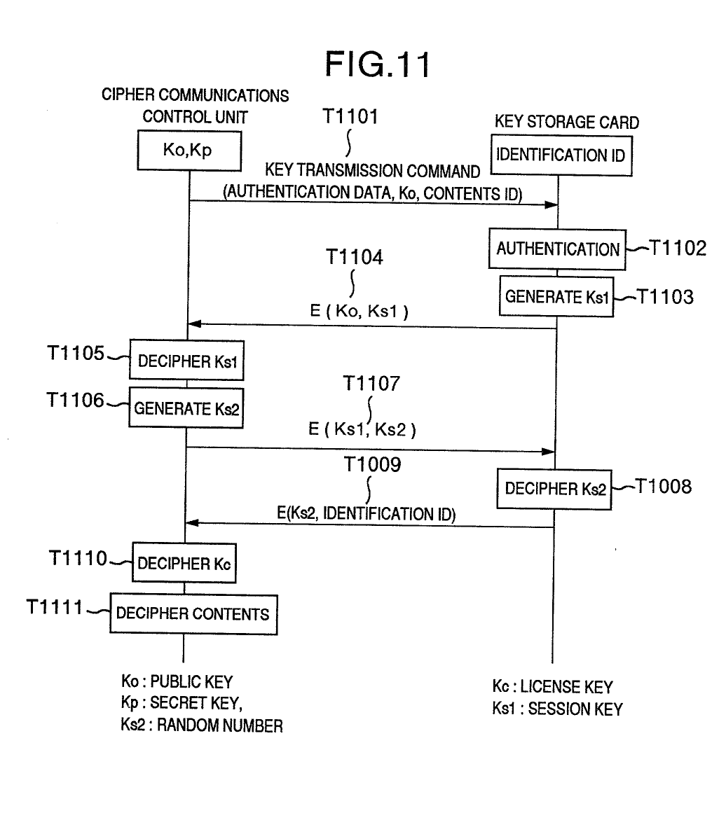

With reference to FIG. 11, the procedure of obtaining a key for deciphering (reproducing) contents will be described. The cipher communications control unit 61 generates a key transmission command and transmits it to the key storage card 53 (T1101), the key transmission command including authentication data of the unit 61 and the public key Ko held beforehand by the unit 61 and paired to the secret key Kp. Upon reception of this command, the card cipher communications control unit 62 of the key storage card 53 authenticates the digital broadcasting data transfer processing apparatus 10 (T1102). The card cipher communications control unit 62 generates a session key Ks1 by using a random number or the like (T1103), enciphers the session key Ks1 by using Ko contained in the key transmission command, and transmits it to the cipher communications control unit 61 of the digital broadcasting data transfer processing apparatus 10 at the transmission originating side (T1104). Upon reception of this, the cipher communications control unit 61 deciphers the ciphered session key Ks1 by using the secret key Kp held in advance to obtain a deciphered session key Ks1 (T1105), and a random number Ks2 is generated (T1106). This random number Ks2 is enciphered by the session key Ks1 and transmitted to the key storage card 53 (T1107). The card cipher communications control unit 62 of the key storage card 53 deciphers the ciphered random number Ks2 by the session key Ks1 to obtain a random number Ks2 (T1108). The identification ID 20 necessary for deciphering contents and license key Kc are enciphered by the random number Ks2 and transmitted to the cipher communications control unit 61 (T1109). The cipher communications control unit 61 deciphers the identification ID and license key enciphered by Ks2 to obtain the identification ID and license key Kc (T1110), and transmits these identification ID and license key Kc to the re-enciphering contents decipher unit 35 to decipher the contents. Also in this case, as described earlier, it is difficult to know the key only by probing signals.

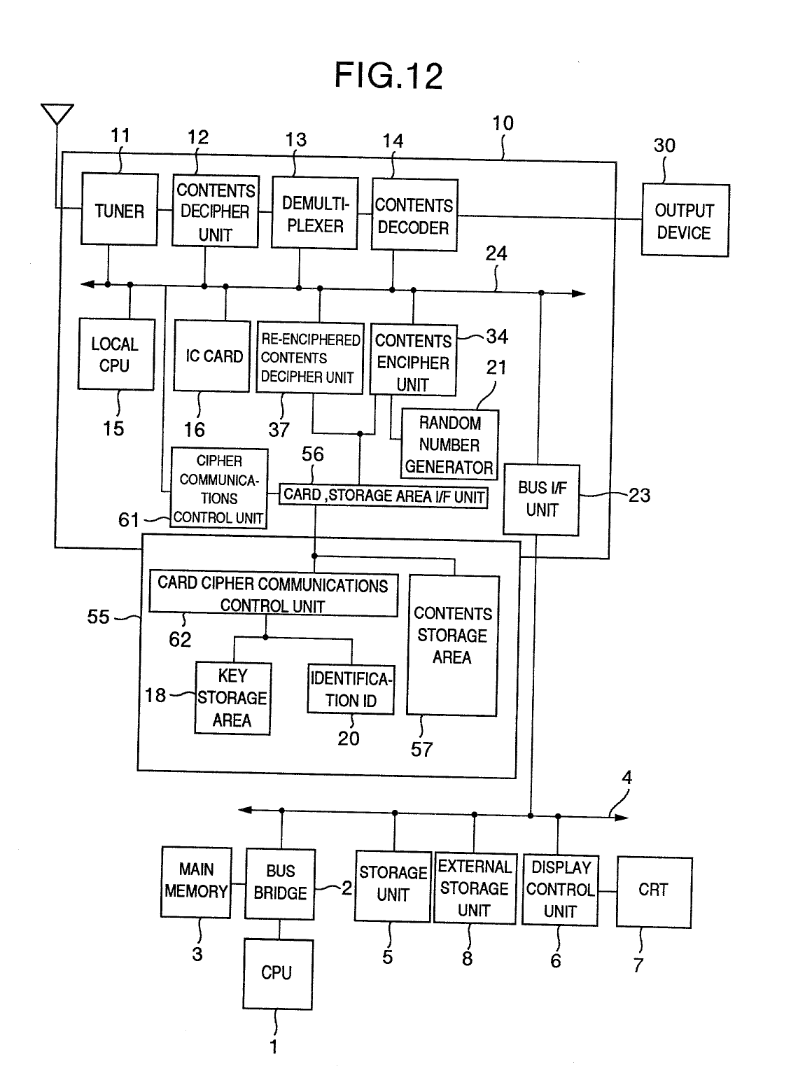

Next, with reference to FIG. 12, the seventh embodiment will be described. In FIG. 12, reference numeral 57 represents a contents storage area for storing enciphered contents, reference numeral 55 represents a storage unit with a key storage area, the storage unit storing in the contents storage area 57 the function of the key storage card for transferring the identification ID and contents key through cipher communications described with the sixth embodiment, and reference numeral 56 represents a card/storage area I/F unit for accessing the contents storage area 57, key storage area and identification ID. The operation of the embodiment having such components will be described. First, an operation of recording contents will be described. An enciphered program is received by the tuner 11 and passes through the contents decipher unit 12, and the demultiplexer 13 demultiplexes the received program into enciphered contents data and an enciphered scramble key Ks. The demultiplexed and enciphered scramble key Ks is deciphered in the IC card 16 under the control of the local CPU 15. The scrambled key Ks deciphered by the local CPU 15 is set to the contents decipher unit 12. The contents data deciphered by the contents decipher unit 12 is sent via the demultiplexer 13 to the contents decoder 14 and contents encipher unit 36. The contents decoded by the contents decoder 14 are output to the output device 30 to listen/view the contents. The contents encipher unit 36 acquires the identification ID 20 through cipher communications, which ID is identification information unique to the broadcasting data transfer processing apparatus, and performs an encipher operation by using the acquired identification ID and a random number generated by the random number generator 21. The generated contents key and contents ID are stored in the key storage area 18 through cipher communications. The contents encipher unit 36 stores the re-enciphered contents data together with the contents ID in the contents storage area 57 via the card/storage area I/F unit. In deciphering the contents, the re-enciphering contents decipher unit 37 reads the enciphered contents ID and enciphered contents data stored in the contents storage area 57 of the storage unit 55 with the key storage area, and also reads the contents key and identification ID corresponding to the contents ID from the key storage area 18 and identification ID 20 through cipher communications to decipher the enciphered contents data. The deciphered contents data is input via the demultiplexer 13 to the contents decoder 14 to be output from the output device 30 and listen/view the contents.

Each time contents are re-enciphered, the number of contents keys in the key storage area 18 increases. Since the key storage area 18 has a limited capacity, it may become full. In such a case, a user is required to have a plurality of storage units with the key storage area and manage them, which is inconvenient. However, with the structure shown in FIG. 12, in accordance with the capacity of the contents storage area, the capacity of the key storage area can be determined properly. Therefore, the inconvenience described above can be alleviated. Further, since the contents and key exist always in unison, it is not necessary to independently manage the key and contents, which is convenient for a user. A group of contents data may be related to one contents key, or the contents storage area may be divided into sub-areas to relate contents in each sub-area to a key. In this manner, the capacity of the key storage area can be reduced. The contents storage area 57 may be an HDD, a semiconductor memory, a DVD-RAM, or a magnetic tape if the electrodes are attached to the case of such media to provide the key storage area and identification ID. By using such media, the storage unit with the key storage area can be realized.

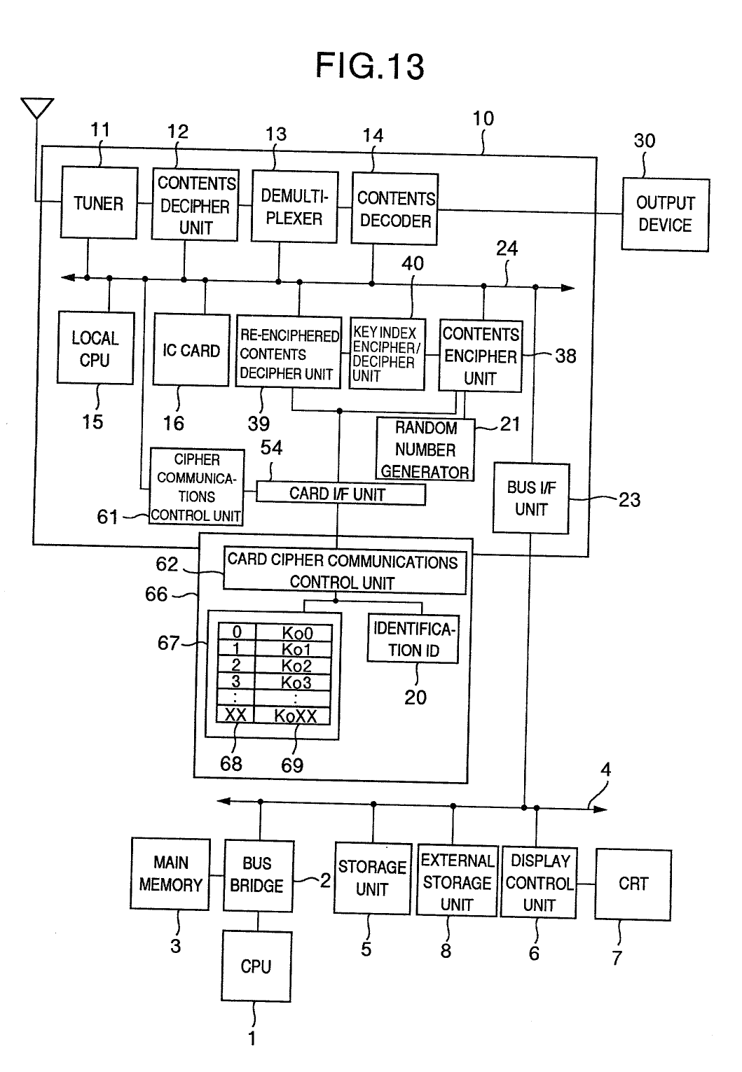

Next, with reference to FIG. 13, the eighth embodiment will be described. In FIG. 13, reference numeral 69 represents a contents key used when enciphered contents are deciphered, reference numeral 68 represents a key index corresponding to the contents key 69, reference numeral 67 represents a key storage area for storing a plurality of pairs of contents keys 69 and key indices 68, and reference numeral 40 represents a key index encipher/decipher unit for enciphering and deciphering the key index.

The operation of the eighth embodiment with these components will be described. First, an operation of recording contents will be described. An enciphered program is received by the tuner 11 and passes through the contents decipher unit 12, and the demultiplexer 13 demultiplexes the received program into enciphered contents data and an enciphered scramble key Ks. The demultiplexed and enciphered scramble key Ks is deciphered in the IC card 16 under the control of the local CPU 15. The scrambled key Ks deciphered by the local CPU 15 is set to the contents decipher unit 12. The contents deciphered by the contents decipher unit 12 are sent via the demultiplexer 13 to the contents decoder 14 and contents encipher unit 38. The contents decoded by the contents decoder 14 are output to the output device 30 to listen/view the contents. By using a random number generated by the random number generator 21, the contents encipher unit 38 generates a key index for determining which contents key is used among a plurality of contents key in the key storage area 67, and transmits this key index through cipher communications to the key storage card 66 to acquire the contents key 69 and identification ID 20 corresponding to the key index 68. By using the acquired contents key and identification ID, the contents data is enciphered, and the key index encipher/decipher unit 40 enciphers the key index by a specific key. The enciphered key index and enciphered contents data are transferred to the main memory 3 via the bus I/F unit 23, and finally stored in the storage unit 5 or external storage unit 8. If the key index encipher/decipher unit enciphers the key index by the specific key and the enciphered key index is the same key index, the same data is used and there is a possibility that the key index is analyzed. In order to avoid this, the key index may be added with redundant data such as a random number and thereafter the key index is enciphered, so that the enciphered result becomes different and such a possibility can be lowered. Next, an operation of reproducing the recorded contents will be described. CPU 1 reads the re-enciphered data stored in the storage unit 5 and inputs it to the re-enciphered contents decipher unit 39 via the PCI bus 4 and bus I/F unit 23. In this case, the key index encipher/decipher unit 40 deciphers the enciphered key stored together with the contents data, by a specific key to obtain a deciphered key index. Then, this key index is transmitted through cipher communications to the key storage card to obtain the contents key 69 and identification ID 20 corresponding to the key index 68. The re-enciphered contents decipher unit deciphers the contents data. The deciphered contents data is input to the demultiplexer 13 to delete unnecessary data such as the contents ID and transfer the remaining data to the contents decoder 14. The contents decoded by the contents decoder 14 are output to the output device 30 to listen/view the contents.

With this embodiment structure, it is not necessary to store a new contents key in the key storage area. Therefore, in enciphering and storing contents, even if the number of contents keys increases, the number of key storage cards will not increase. A user is required to manage only one card so that key management is simple and easy. By changing the contents key and identification ID for each key storage card, even if a key storage card different from that used during encipher is used to reproduce contents and even if the same key index is used, it is not possible to decipher contents data because the contents key and identification ID are different. A copyright protection is therefore possible.

As described so far, according to the above-described embodiments, in a broadcasting data receiving apparatus, since the enciphered key for deciphering enciphered contents is deciphered and re-enciphered, it is possible to store enciphered contents themselves in the storage unit. Therefore, even for an information processing apparatus such as PC on which file utility applications run, a data receiving apparatus can be provided which can protect a copyright of contents and can listen/view contents even if the work key Kw is changed. By making the function of deciphering and re-enciphering the enciphered key for deciphering enciphered contents to have a removable circuit structure, it is possible to allow another data processing apparatus to listen/view contents.

What is claimed is:

1. A data receiving apparatus for receiving enciphered data to be deciphered by a data decipher key whose contents are changed as time lapses, the data receiving apparatus comprising:
a receiver for receiving data enciphered by a first encipher key; and
an encipher unit connected to a decipher unit for deciphering at least one of the received data and the data decipher key enciphered by a second encipher key, said encipher unit enciphering the data deciphered or the data decipher key by a re-encipher key,
wherein the re-enciphered data or the data decipher key is stored in a storage medium connected to said encipher unit.

2. A data receiving apparatus according to claim 1, further comprising a multiplexer connected to said encipher unit, wherein said decipher unit deciphers the data decipher key, said encipher unit enciphers the deciphered data decipher key, and said multiplexer checks a correspondence between the enciphered data decipher key and received data and stores the corresponded data decipher key and received data in the storage medium.

3. A data receiving apparatus according to claim 2, wherein said encipher unit generates a re-decipher key for deciphering the data decipher key enciphered by said encipher unit.

4. A data receiving apparatus according to claim 2, further comprising first and second demultiplexers connected to said receiver, wherein said receiver receives transmission information including the enciphered data and enciphered data decipher key, said first demultiplexer demultiplexes the transmission information into the data and data decipher key, the demultiplexed data being deciphered and transmitted to a display unit, and said second demultiplexer demultiplexes the transmission information into the data and data decipher key, the demultiplexed data decipher key being transmitted to said decipher unit and the demultiplexed data being transmitted to said multiplexer.

5. A data receiving apparatus according to claim 2, wherein said encipher unit uses the re-encipher key generated in accordance with identification information for identifying the data receiving apparatus.

6. A data receiving apparatus according to claim 5, wherein said encipher unit uses the re-encipher key generated in accordance with a random number generated by a random number generator.

7. A data receiving apparatus according to claim 2, further comprising an interface unit for connection to a processing unit having said decipher unit, wherein said encipher unit uses the re-enciphering key generated in accordance with identification information for identifying the processing unit.

8. A data receiving apparatus according to claim 7, wherein said encipher unit further uses the re-encipher key generated in accordance with a random number generated by a random number generator.

9. A data receiving apparatus according to claim 2, wherein said data receiving apparatus includes the storage medium.

10. A data receiving apparatus according to claim 2, wherein the data receiving apparatus is connected to the storage medium via a bus.

11. A data receiving apparatus according to claim 2, further comprising:
a second decipher unit for deciphering the data decipher key enciphered by said encipher unit in accordance with an input from a user of the data receiving apparatus and for deciphering the data stored in the storage medium by using the deciphered data decipher key; and
an output unit connected to said second decipher unit for outputting the deciphered data.

12. A data receiving apparatus according to claim 1, wherein said decipher unit deciphers the received data, and said encipher unit enciphers the deciphered data and generates a second decipher key for deciphering the enciphered data, and wherein the data enciphered by said encipher unit is stored in the storage medium and the second decipher key is stored in a second storage medium, being relating the data to the second decipher key.

13. A data receiving apparatus according to claim 12, further comprising first and second demultiplexers connected to said receiver, wherein said receiver receives transmission information including the enciphered data and enciphered data decipher key, said first demultiplexer demultiplexes the transmission information into the data and data decipher key, the demultiplexed data being deciphered and transmitted to a display unit, and said second demultiplexer demultiplexes the transmission information into the data and data decipher key, the demultiplexed data being transmitted to said multiplexer.

14. A data receiving apparatus according to claim 12, wherein said encipher unit uses the re-encipher key generated in accordance with identification information for identifying the data receiving apparatus.

15. A data receiving apparatus according to claim 14, wherein said encipher unit further uses the re-encipher key generated in accordance with a random number generated by a random number generator.

16. A data receiving apparatus according to claim 12, further comprising an interface unit for connection to a processing unit having said decipher unit, wherein said encipher unit uses the re-enciphering key generated in accordance with identification information for identifying the processing unit.

17. A data receiving apparatus according to claim 16, wherein said encipher unit uses the re-encipher key generated in accordance with a random number generated by a random number generator.

18. A data receiving apparatus according to claim 12, wherein said receiving apparatus includes the storage medium.

19. A data receiving apparatus according to claim 12, wherein the data receiving apparatus is connected to the storage medium via a bus.

20. A data receiving apparatus according to claim 12, further comprising a second interface unit for connection to a second processing unit having the second storage medium.

21. A data receiving apparatus according to claim 12, further comprising:
a second decipher unit for deciphering the data stored in the storage medium by using the second decipher key in accordance with an input from a user of the data receiving apparatus; and
an output unit connected to said second decipher unit for outputting the deciphered data.

22. A data receiving apparatus according to claim 1, wherein said receiver receives information broadcast from a broadcaster, the information containing the enciphered data and the enciphered data decipher key whose contents are changed at a predetermined interval.

23. A data receiving apparatus according to claim 1, wherein the first encipher key is same as the second encipher key.

24. A data reproducing apparatus for reproducing enciphered data to be deciphered by a data decipher key whose contents are changed as time lapses, the data reproducing apparatus comprising:
means for reading the data enciphered by a first encipher key and the data decipher key enciphered by a second encipher key from a storage medium;
means for deciphering the data decipher key;
means for deciphering the read data by using the deciphered data decipher key; and
means for outputting the deciphered data.
